(19) United States
(12) Patent Application Publication
(10) Pub. No.: US 2017/0192336 A1
(43) Pub. Date: Jul. 6, 2017

(54) DISPLAY UNIT AND ELECTRONIC APPARATUS

(71) Applicant: SONY CORPORATION, TOKYO (JP)

(72) Inventors: YURIKO KAINO, KANAGAWA (JP); AYA SHUTO, KANAGAWA (JP); KEN KOBAYASHI, KANAGAWA (JP); HIDEHIKO TAKANASHI, KANAGAWA (JP)

(21) Appl. No.: 15/126,787

(22) PCT Filed: Feb. 24, 2015
(86) PCT No.: PCT/JP2015/000901

§ 371 Date: Sep. 16, 2016

(30) Foreign Application Priority Data
Mar. 27, 2014 (JP) 2014-066717

(51) Int. Cl. G02F 1/167; G02F 1/1335

(52) U.S. Cl. CPC G02F 1/167; G02F 1/133553; G02F 2001/1678

(57) ABSTRACT

There is provided a display unit including: in an insulating liquid, migrating particles; a porous layer including non-migrating particles and formed of a fibrous structure, the non-migrating particles having an optical reflectance different from an optical reflectance of the migrating particles; and an acidic additive and a basic additive.

### CROSS REFERENCE TO RELATED APPLICATIONS

This application claims the benefit of Japanese Priority Patent Application JP 2014-066717 filed Mar. 27, 2014, the entire contents of which are incorporated herein by reference.

### TECHNICAL FIELD

The present technology relates to a display unit including an electrophoretic element and to an electronic apparatus provided with the display unit.

### BACKGROUND ART

In recent years, low-power display units (displays) with high image quality have been in increasing demand, as mobile devices represented by mobile phones and portable information terminals have become widespread. In particular, distribution service of digital books has recently started, and a display having a display quality suitable for reading is desired.

Although displays such as a cholesteric liquid crystal display, an electrophoretic display, an electric-redox-type display, and a twisting ball display have been proposed as such displays, a reflection-type display is advantageous for reading. In the reflection-type display, bright display is performed with use of reflection (scattering) of external light in a manner similar to that of a paper and thus, display quality close to that of the paper is achieved.

Among the reflection-type displays, an electrophoretic display using electrophoresis phenomenon that is low in power consumption and high in response speed is expected to be a major display. As the display method, the following two methods have been mainly proposed.

In a first method, two kinds of charged particles are dispersed in an insulating liquid, and the charged particles are moved in response to an electric field. The two kinds of charged particles are different in optical reflection characteristics from each other, and its polarities are opposite to each other. In this method, a distribution state of the charged particles is changed in response to the electric field, and thus an image is displayed.

In a second method, charged particles are dispersed in an insulating liquid, and a porous layer is disposed (for example, PTL 1). In this method, the charged particles move through pores of the porous layer in response to the electric field. For example, the porous layer may include a fibrous structure formed of a polymer material and non-migrating particles that are held by the fibrous structure and have optical reflection characteristics different from those of the charged particles. In such an electrophoretic display, the display is switched over by movement of the charged particles through the pores in response to the electric field.

### CITATION LIST

### Patent Literature

[PTL 1] JP-A-2012-22296

### SUMMARY

### Technical Problem

In the electrophoretic display including the porous layer and the charged particles, display memory property in which the displayed image is held without diffusion of the charged particles after application of the electric field is stopped is desired; however, the property is not sufficient.

It is desirable to provide a display unit and an electronic apparatus each having high display memory property.

### Solution to Problem

According to an embodiment of the technology, there is provided a display unit including: in an insulating liquid, migrating particles; a porous layer including non-migrating particles and formed of a fibrous structure, the non-migrating particles having an optical reflectance different from an optical reflectance of the migrating particles; and an acidic additive and a basic additive.

According to an embodiment of the technology, there is provided an electronic apparatus provided with a display unit. The display unit includes: in an insulating liquid, migrating particles; a porous layer including non-migrating particles and formed of a fibrous structure, the non-migrating particles having an optical reflectance different from an optical reflectance of the migrating particles; and an acidic additive and a basic additive.

In the display unit according to the embodiment of the technology, the acidic additive and the basic additive are added to the insulating liquid, which moderates an internal electric field generated in the electrophoretic element after application of the electric field is stopped.

### Advantageous Effects of Invention

According to the display unit and the electronic apparatus of the respective embodiments of the technology, the acidic additive and the basic additive are added into the insulating liquid to moderate the internal electric field generated in the electrophoretic element after the application of the electric field is stopped. Therefore, diffusion of the migrating particles after the application of the electric field is stopped is suppressed. Consequently, it becomes possible to improve display memory property. Incidentally, effects described here are non-limiting. Effects achieved by the technology may be one or more of effects described in the present disclosure.

It is to be understood that both the foregoing general description and the following detailed description are exemplary, and are provided to provide further explanation of the technology as claimed.

### BRIEF DESCRIPTION OF DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a plan view illustrating a structure of an electrophoretic element according to an embodiment of the technology.

FIG. 2 is a sectional diagram illustrating a structure of the electrophoretic element illustrated in FIG. 1.

FIG. 3 is a sectional diagram illustrating a structure of a display unit using the electrophoretic element of FIG. 1 and the like.

FIG. 4 is a sectional diagram for explaining operation of the display unit illustrated in FIG. 3.

FIG. 5A is a perspective view illustrating an appearance of an application example 1.

FIG. 5B is a perspective view illustrating another example of an electronic book illustrated in FIG. 5A.

FIG. 6 is a perspective view illustrating an appearance of an application example 2.

FIG. 7 is a characteristic diagram illustrating relationship between an elapsed time after application of an electric field is stopped and a reflectance in an experimental example 2.

FIG. 8 is a characteristic diagram illustrating relationship between an elapsed time after application of an electric field is stopped and a reflectance in an experimental example 3.

FIG. 9 is a characteristic diagram illustrating relationship between an elapsed time after application of an electric field is stopped and a reflectance in an experimental example 7.

### DESCRIPTION OF EMBODIMENT

Hereinafter, an embodiment of the technology will be described in detail with reference to drawings. Note that description will be given in the following order.

1. Embodiment (electrophoretic element)
2. Application examples (display unit and electronic apparatus)

### 3. Examples

### 1. Embodiment

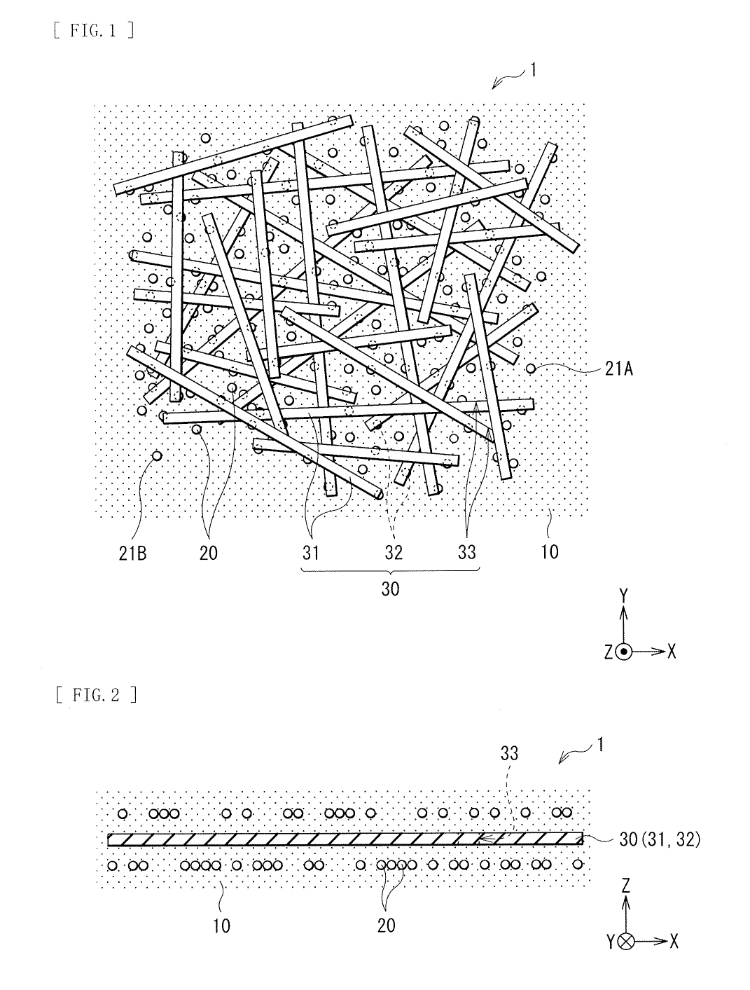

FIG. 1 illustrates a planar structure of an electrophoretic element (an electrophoretic element 1) according to an embodiment of the technology, and FIG. 2 illustrates a sectional structure of the electrophoretic element 1. The electrophoretic element 1 uses electrophoresis phenomenon to generate contrast, and may be applied to, for example, various electronic apparatuses such as a display unit. The electrophoretic element 1 includes migrating particles 20 and a porous layer 30 including pores 33 in an insulating liquid 10. In the present embodiment, an acidic additive 21A and a basic additive 21B are further included in the insulating liquid 10. Note that FIGS. 1 and 2 each schematically illustrate the structure of the electrophoretic element 1, and a dimension and a shape of the electrophoretic element 1 may be different from an actual dimension and an actual shape.

The insulating liquid 10 may be formed of, for example, an organic solvent such as paraffin and isoparaffin. One kind of organic solvent or a plurality of kinds of organic solvents may be used for the insulating liquid 10. Viscosity and a refractive index of the insulating liquid 10 may be desirably as small as possible. Mobility (response speed) of the migrating particles 20 is improved as the viscosity of the insulating liquid 10 is decreased. In addition, energy (consumed power) necessary for movement of the migrating particles 20 is accordingly decreased. When the refractive index of the insulating liquid 10 is decreased, a difference between the refractive index of the insulating liquid 10 and a refractive index of the porous layer 30 is increased, and a reflectance of the porous layer 30 is increased.

For example, a coloring agent, a charge control agent, a dispersion stabilizer, a viscosity modifier, a surfactant, a resin, or the like may be added to the insulating liquid 10.

The migrating particles 20 dispersed in the insulating liquid 10 are one or two or more charged particles, and such charged migrating particles 20 move through the pores 33 in response to an electric field. The migrating particles 20 have arbitrary optical reflection characteristics (an optical reflectance), and contrast (CR) occurs due to difference between the optical reflectance of the migrating particles 20 and the optical reflectance of the porous layer 30. For example, the migrating particles 20 may perform bright display and the porous layer 30 may perform dark display, or the migrating particles 20 may perform the dark display and the porous layer 30 may perform the bright display.

When the electrophoretic element 1 is viewed from the outside, the migrating particles 20 may be visually confirmed as, for example, white or a color close to white in the case where the migrating particles 20 perform the bright display, and may be visually confirmed as, for example, black or a color close to block in the case where the migrating particles 20 perform the dark display. The color of the migrating particles 20 is not particularly limited as long as the contrast occurs. For example, the color may be red or blue.

For example, the migrating particles 20 may be formed of particles (powder) of an organic pigment, an inorganic pigment, a dye, a carbon material, a metallic material, a metal oxide, glass, and a polymer material (a resin). One kind or two or more kinds thereof may be used for the migrating particles 20. The migrating particles 20 may be formed of crushed particles, capsule particles, or the like of a resin solid content containing the above-described particles. Note that materials equivalent to the above-listed carbon material, metallic material, metal oxide, glass, and polymer material are excluded from materials equivalent to the above-mentioned organic pigment, inorganic pigment, and dye. The particle diameter of each of the migrating particles 20 may be, for example, about 10 nanometers or larger and about 500 nanometers or smaller, and more preferably, about 50 nanometers or larger and about 200 nanometers or smaller.

Examples of the above-described organic pigment may include azo pigments, metal complex azo pigments, polycondensation azo pigments, flavanthrone pigments, benzimidazolone pigments, phthalocyanine pigments, quinacridone pigments, anthraquinone pigments, perylene pigments, perinone pigments, anthrapyridine pigments, pyranthrone pigments, dioxazine pigments, thioindigo pigments, isoindolinone pigments, quinophthalone pigments, and indanthrene pigments. Examples of the inorganic pigment may include zinc flower, antimony white, black iron oxide, titanium boride, red iron oxide, mapico yellow, minium, cadmium yellow, zinc sulphide, lithopone, barium monosulfide, cadmium selenide, calcium carbonate, barium sulfate, lead chromate, lead sulfate, barium carbonate, white lead, and alumina white. Examples of the dye may include nigrosine dyes, azo dyes, phthalocyanine dyes, quinophthalone dyes, anthraquinone dyes, and methine dyes. Examples of the carbon material may include carbon black. Examples of the metallic material may include gold, silver, and copper. Examples of the metal oxide may include titanium oxide, zinc oxide, zirconium oxide, barium titanate, potassium titanate, copper-chromium oxide, copper-manganese oxide, copper-iron-manganese oxide, copper-chromium-manganese oxide, and copper-iron-chromium oxide. Examples of the polymer material may include a high molecular compound into which a functional group having an optical absorption range in a visible light region is introduced. The kind of the polymer material is not particularly limited as long as such a high molecular compound having the optical absorption range in the visible light region is adopted.

A specific material of the migrating particles 20 may be selected according to a role of the migrating particles 20 to generate contrast, for example. When the migrating particles 20 perform the bright display, for example, a metal oxide such as titanium oxide, zinc oxide, zirconium oxide, barium titanate, and potassium titanate, or the like may be used for the migrating particles 20. When the migrating particles 20 perform the dark display, for example, a carbon material such as carbon black, or a metal oxide such as copper-chromium oxide, copper-manganese oxide, copper-iron-manganese oxide, copper-chromium-manganese oxide, and copper-iron-chromium oxide, or the like may be used for the migrating particles 20. Among them, a carbon material may be preferably used for the migrating particles 20. The migrating particles 20 formed of the carbon material exhibit excellent chemical stability, excellent mobility, and excellent light absorption property.

The content (density) of the migrating particles 20 in the insulating liquid 10 may be, for example, about 0.1 wt % to about 10 wt % both inclusive, although it is not particularly limited. A shielding property and mobility of the migrating particles 20 are secured in this density range. Specifically, when the content of the migrating particles 20 is lower than 0.1 wt %, it may be difficult for the migrating particles 20 to shield (hide) the porous layer 30, and contrast may not be sufficiently generated. On the other hand, when the content of the migrating particles 20 is higher than 10 wt %, dispersibility of the migrating particles 20 may decrease. Therefore, the migrating particles 20 are difficult to migrate, which leads to a possibility of occurrence of agglomeration in some cases.

The migrating particles 20 may be preferably readily dispersed and charged in the insulating liquid 10 for a long time, and may be less easily adsorbed on the porous layer 30. Therefore, for example, a dispersant may be added to the insulating liquid 10. The dispersant and the charge control agent may be used together.

For example, the dispersant or the charge control agent may have one or both of positive charge and negative charge, and may increase charged amount in the insulating liquid 10 as well as may disperse the migrating particles 20 by electrostatic repulsion. Examples of such a dispersant may include Solsperce series made by The Lubrizol Corporation, BYK series or Anti-Terra series made by BYK-Chemic GmbH, Span series made by TCI America, and Hypermer series made by Croda International Plc.

To improve dispersibility of the migrating particles 20, surface treatment may be performed on the migrating particles 20. Examples of the surface treatment may include rosin treatment, surfactant treatment, pigment derivative treatment, coupling agent treatment, graft polymerization treatment, and microencapsulation treatment. Among them, performing the graft polymerization treatment, the microencapsulation treatment, or a combination of these treatments makes it possible to maintain long-term dispersion stability of the migrating particles 20.

For example, a material (an adsorptive material) that contains a functional group capable of being adsorbed on the surface of the migrating particles 20 and a polymeric functional group may be used in such surface treatment. The kind of the functional group capable of being adsorbed is determined depending on the material of the migrating particles 20. For example, when the migrating particles 20 are formed of a carbon material such as carbon black, an aniline derivative such as 4-vinyl aniline may be absorbed. When the migrating particles 20 are formed of a metal oxide, an organosilane derivative such as methacrylate-3-(trimethoxysilyl)propyl may be absorbed. Examples of the polymeric functional group may include a vinyl group, an acrylic group, and a methacryl group.

A polymeric functional group may be introduced on the surface of the migrating particles 20, and a material may be grafted thereon to perform the surface treatment (a graft material). For example, the graft material may contain a polymeric functional group and a functional group for dispersion. The functional group for dispersion is capable of dispersing the migrating particles 20 in the insulating liquid 10 and maintaining dispersibility by steric hindrance. When the insulating liquid 10 is, for example, paraffin, a branched-alkyl group or the like may be used as the functional group for dispersion. Examples of the polymeric functional group may include a vinyl group, an acryl group, and a methacryl group. To cause polymerization and graft of the graft material, for example, a polymerization initiator such as azobisisobutyronitrile (AIBN) may be used.

Details of a method of dispersing the migrating particles 20 in the insulating liquid 10 as described above are described in books such as “Dispersion technology of ultrafine particles and evaluation thereof: surface treatment and fine grinding, as well as dispersion stability in air/liquid/polymer (Science & Technology Co., Ltd.)”.

In the present embodiment, the acidic additive 21A and the basic additive 21B are added to the insulating liquid 10 as described above. Although the detail will be described later, adding the acidic additive 21A and the basic additive 21B to the insulating liquid 10 suppresses diffusion of the migrating particles 20 after the application of the electric field is stopped.

The acidic additive 21A has a so-called surfactant structure that is formed of a hydrophilic part configured of a polar group, and a hydrophobic part. Examples of the polar group may include a group having a succinic anhydride structure and a group having a succinic acid structure. The hydrophobic part may be formed of, for example, a straight chain or branched hydrocarbon group having 8 or more carbon atoms. Specifically, examples of such a group may include an octyl group, a nonyl group, a decyl group, an undecyl group, a dodecyl group, a vinyl group, and an allyl group. Specifically, for example, an alkylene succinic anhydride represented by the following expressions (1) and (2), succinic acid, and a succinic acid derivative (for example, sodium di(2-ethylhexyl) sulfosuccinate; an expression (3)), polycarboxylic acid alkyl represented by an expression (4), or the like are exemplified; however, this is not limitative. Incidentally, n in the expression (1) is about 5 to about 30, and R1 and R2 in the expressions (1) and (2) denote a hydrogen atom or an alkyl group. Moreover, the expression (4) has an ester structure in any of the main chain and the side chain. Alternatively, any of the main chain and the side chain may be a polycarboxylic acid. Examples of a specific compound represented by the expression (4) may include Hypermer KD-9, KD-4, KD-8, KD-12, and KD-57. An acid number of the acidic additive 21A may be preferably 100 or larger, and more preferably 120 or larger and 450 or lower, further preferably 300 or larger and 420 or lower.

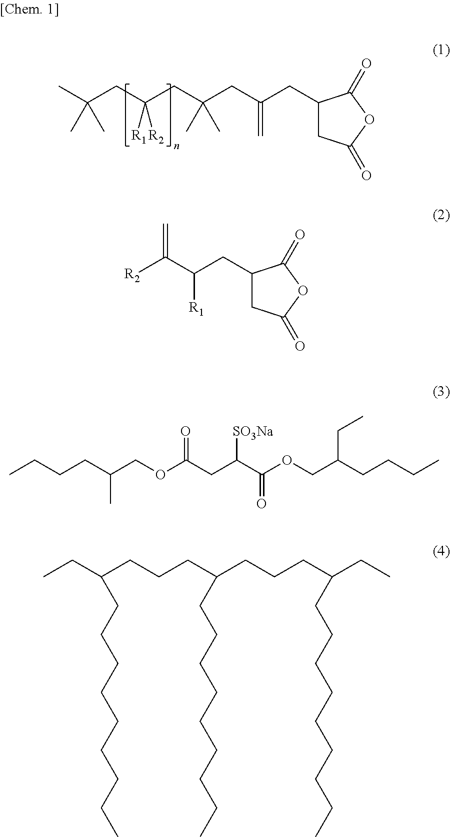

For example, one of a primary amine, a secondary amine, and a tertiary amine that are capable of being dissolved in an organic solvent may be preferably used as the basic additive 21B. In addition, an amine having a succinic imide structure may be used. Specifically, compounds represented by the following expressions (5) to (8), dimethyldecylamine (DMDA, the expression (5)), trioctylamine (TOA, the expression (6)), 2-ethylhexylamine (EHA, the expression (7)), OLOA 1200 in which n is about 20 to about 25 (the expression (8)) may be used. In addition, N-methyldioleylamine, N-methyldodecylamine, dimethyldodecylamine, dimethyldecylamine, dimethyloctylamine, dimethyl(2-ethylhexyl)amine, dimethylhexylamine, dimethylcyclohexylamine, dimethylpentylamine, dimethylbutylamine, dimethylisopropylamine, dimethylethylamine, trioctylamine, tri(2-ethylhexyl)amine, trihexylamine, triamylamine, tripentylamine, tributylamine, di(2-ethylhexyl)amine, 2-ethylhexylamine, dimethylhexylamine, trihexylamine, and the like may be exemplified without limitation. An amine value of the basic additive 21B may be preferably, for example, about 100 or more and about 500 or less, and more preferably about 150 or more and about 430 or less.

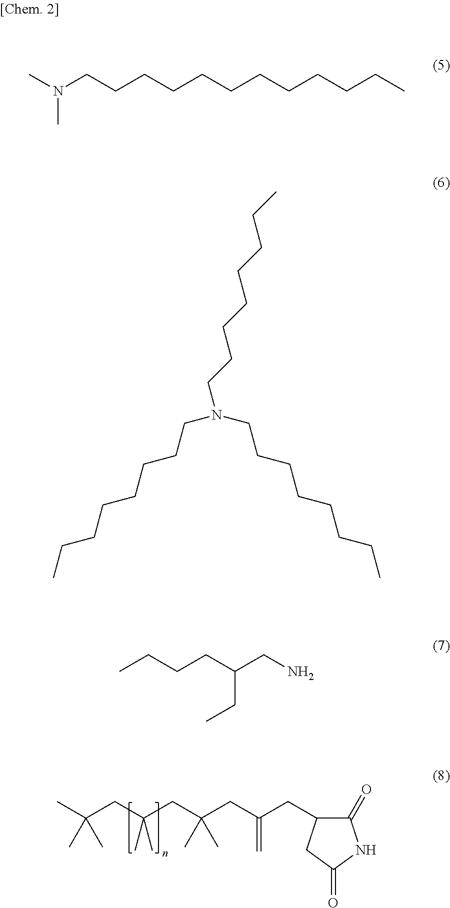

In the insulating liquid 10, one or more of the above-described acidic additives 21A and one or more of the above-described basic additives 21B may be preferably used. An additional quantity ratio of the acidic additive 21A to the basic additive 21B may be preferably about 1/1 in molar ratio in the insulating liquid 10, and the effects of the present technology are obtainable when the additional quantity ratio is within the range of 2/1 to 1/1.2.

The porous layer 30 is capable of shielding the migrating particles 20, and has a fibrous structure 31 and non-migrating particles 32 held by the fibrous structure 31. The porous layer 30 is a three-dimensional structure (an irregular network structure such as a non-woven fabric) formed of the fibrous structure 31, and is provided with a plurality of apertures (pores 33). Forming the three-dimensional structure of the porous layer 30 by the fibrous structure 31 allows light (outside light) to be reflected irregularly (multiply scattered), and increases the reflectance of the porous layer 30. Accordingly, even when the thickness of the porous layer 30 is small, a high reflectance is allowed to be obtained, and the contrast of the electrophoretic element 1 is allowed to be improved as well as energy necessary for movement of the migrating particles 20 is allowed to be decreased. Moreover, the average pore diameter of the pores 33 becomes large, and a lot of pores 33 are provided in the porous layer 30. Accordingly, the migrating particles 20 are easily moved through the pores 33, the response speed is increased, and the energy necessary for movement of the migrating particles 20 is further decreased. The thickness of such a porous layer 30 may be, for example, about 5 micrometers to about 100 micrometers both inclusive.

The fibrous structure 31 is a fibrous substance having a length sufficient with respect to a fiber diameter. For example, a plurality of fibrous structures 31 may be collected and randomly overlapped to form the porous layer 30. One fibrous structure 31 may be randomly tangled to form the porous layer 30. Alternatively, the porous layer 30 formed of one fibrous structure 31 and the porous layer 30 formed of a plurality of fibrous structures 31 may be mixed.

For example, the fibrous structure 31 may straightly extend. The fibrous structure 31 may have any shape, and for example, may be frizzled or folded halfway. Alternatively, the fibrous structure 31 may be branched halfway.

The minimum fiber diameter of the fibrous structure 31 may be preferably, for example, about 500 nanometers or lower, and more preferably about 300 nanometers or lower. The average fiber diameter of the fibrous structure 31 may be preferably, for example, about 0.1 micrometer or larger and about 10 micrometers or lower; however may be out of the above-described range. As the average fiber diameter is decreased, light is easily reflected irregularly, and the pore diameter of the pore 33 is increased. The fiber diameter is determined so that the fibrous structure 31 holds the non-migrating particles 32. For example, the average fiber diameter may be determined through microscope observation using a scanning electron microscope or the like. The average length of the fibrous structure 31 is arbitrary. For example, the fibrous structure 31 may be formed by a phase separation method, a phase inversion method, an electrostatic (electric field) spinning method, a melt spinning method, a wet spinning method, a dry spinning method, a gel spinning method, a sol-gel method, a spray applying method, or the like. Using such methods makes it possible to easily and stably form the fibrous structure 31 that has a sufficient length with respect to the fiber diameter.

The fibrous structure 31 may be preferably formed of nanofibers. Here, the nanofiber is a fibrous substance having a fiber diameter of about 1 nanometer to about 1000 nanometers both inclusive and a length hundred times or more larger than the fiber diameter. Using such a nanofiber as the fibrous structure 31 allows light to be easily reflected irregularly, and makes it possible to improve the reflectance of the porous layer 30. In other words, it is possible to improve the contrast of the electrophoretic element 1. In addition, in the fibrous structure 31 formed of the nanofibers, the percentage of the pores 33 per unit volume becomes large, and the migrating particles 20 easily move through the pores 33. Therefore, it is possible to decrease the energy necessary for movement of the migrating particles 20. The fibrous structure 31 formed of the nanofibers may be preferably formed by the electrostatic spinning method. Using the electrostatic spinning method makes it possible to easily and stably form the fibrous structure 31 having a small fiber diameter.

The fibrous structure 31 may preferably have an optical reflectance different from that of the migrating particles 20. Therefore, the contrast by a difference between the optical reflectance of the porous layer 30 and the optical reflectance of the migrating particles 20 is easily formed. The fibrous structure 31 exhibiting optical transparency (clear and colorless) in the insulating liquid 10 may be used.

The pores 33 are formed by the plurality of overlapped fibrous structures 31 or one tangled fibrous structure 31. The pores 33 may preferably have an average pore diameter as large as possible so as to facilitate movement of the migrating particles 20 through the pores 33. The average pore diameter of the pores 33 may be, for example, about 0.1 micrometer or more and about 10 micrometers or less.

The non-migrating particles 32 are one or two or more particles that are fixed to the fibrous structure 31 and do not perform electrophoresis. The non-migrating particles 32 may be embedded in the inside of the fibrous structure 31 holding the non-migrating particles 32, or may be partially exposed from the fibrous structure 31.

The non-migrating particles 32 have an optical reflectance different from the optical reflectance of the migrating particles 20. The non-migrating particles 32 may be formed of the material similar to the material of the migrating particles 20 described above. More specifically, when the non-migrating particles 32 (the porous layer 30) perform the bright display, the above-described material in the case where the migrating particles 20 perform the bright display may be used. When the non-migrating particles 32 perform the dark display, the above-described material in the case where the migrating particles 20 perform the dark display may be used. When the bright display is performed by the porous layer 30, the non-migrating particles 32 may be preferably formed of a metal oxide. As a result, it is possible to obtain excellent chemical stability, excellent fixity, and excellent optical reflectivity. The material of the non-migrating particles 32 and the material of the migrating particles 20 may be the same as each other or may be different from each other. The color visually confirmed from the outside at the time when the non-migrating particles 32 perform the bright display or the dark display is similar to those in description about the migrating particles 20 described above.

For example, such a porous layer 30 may be formed by the following methods. First, the material of the fibrous structure 31 such as polymer material is dissolved in an organic solvent or the like, to prepare a spinning solution. Then, the non-migrating particles 32 are added to the spinning solution, and the resultant solution is sufficiently stirred to disperse the non-migrating particles 32. Finally, spinning is performed from the spinning solution by, for example, the electrostatic spinning method to fix the non-migrating particles 32 to the fibrous structure 31, and the porous layer 30 is formed. In the porous layer 30, boring may be performed on a polymer film with use of a laser to form the pores 33, or a fabric woven of synthetic fibers and the like, open cell porous polymer, or the like may be used for the porous layer 30.

The electrophoretic element generates contrast with use of the difference between the optical reflectance of the migrating particles and the optical reflectance of the porous layer as described above. Specifically, the optical reflectance of one of the migrating particles and the porous layer that perform the bright display is higher than the optical reflectance of the other that perform the dark display. Performing such display allows the optical reflectance in performing the bright display to be remarkably increased with use of light irregular reflection by the porous layer (the three-dimensional structure). Therefore, the contrast is remarkably improved accordingly.

In the electrophoretic element, specifically, the migrating particles exhibit the following behavior, and thus display is performed. When a voltage is applied between the pair of electrodes, the migrating particles move to the corresponding electrode side through the pores of the porous layer within a range of the electric field generated by the application of the voltage. One of the bright display and the dark display is performed depending on a region where the migrating particles are moved and a region where the migrating particles are not moved, and thus an image is displayed. Incidentally, the optical reflectance of the non-migrating particles may be preferably set higher than the optical reflectance of the migrating particles, and the bright display may be preferably performed by the porous layer and the dark display may be preferably performed by the migrating particles.

A reflection-type display using the electrophoretic element and the like is expected to be a promising candidate of a display of a mobile device used for reading and the like because the reflection-type display is low in power consumption, is high in response speed, and has a right weight and a display quality close to a paper. However, further reduction in power consumption is desired. Examples of a method of reducing the consumed power may include improvement of the display memory property. The display image is held by remain of the moved migrating particles on the electrode side after the application of the electric field (the applied electric field) is stopped, and accordingly the electrophoretic element exhibits the display memory property. However, in a typical electrophoretic element, diffusion of migrating particles starts when the application of the voltage is stopped, and therefore, sufficient display memory property is not obtainable.

In such an electrophoretic element, when a basic additive is excessively added to the insulating liquid, there is a tendency that the response speed is increased but the display memory property is degraded. On the other hand, when an acidic additive is added to the insulating liquid, there is a tendency that the display memory property is exhibited but the migrating particles are easily absorbed on the fibrous structure, which degrades the response speed remarkably.

In contrast, in the electrophoretic element 1 of the present embodiment, both of the acidic additive 21A and the basic additive 21B are added to the insulating liquid 10. As a result, the internal electric field (specifically, an electric field in a direction opposite to the applied electric field) generated after the electric field is applied is moderated by movement of the acidic additive 21A and the basic additive 21B that have mobility higher than that of the migrating particles 20, and therefore, diffusion of the migrating particles 20 is suppressed.

As described above, in the electrophoretic element 1 of the present embodiment, the acidic additive 21A and the basic additive 21B are added to the insulating liquid 10. Therefore, the internal electric field generated in the element after the application of the electric field is stopped is moderated. As a result, diffusion of the migrating particles 20 after the application of the electric field is stopped is suppressed, which makes it possible to improve the memory characteristics of the electrophoretic element 1.

### 2. Application Examples

### (Display Unit)

Next, application examples of the above-described electrophoretic element 1 will be described. For example, the electrophoretic element 1 may be applied to a display unit.

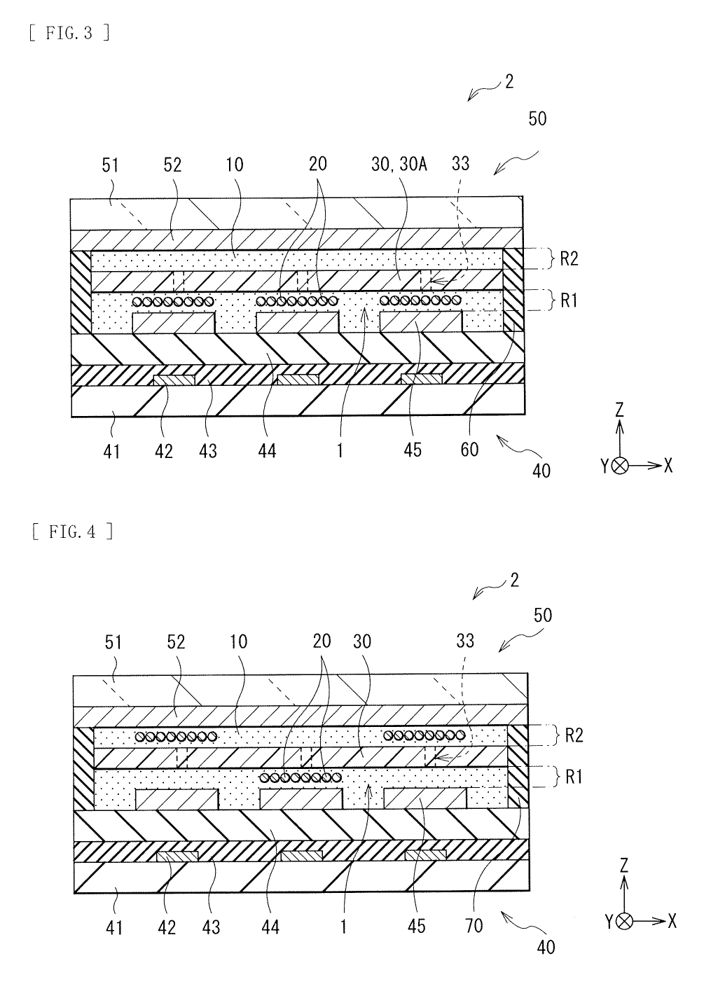

FIG. 3 illustrates an example of a sectional structure of a display unit (a display unit 2) using the electrophoretic element 11. The display unit 2 is an electrophoretic display (so-called electronic paper display) that displays an image (for example, character information) with use of electrophoresis phenomenon, and has the electrophoretic element 1 between a drive substrate 40 and an opposing substrate 50. A spacer 60 adjusts a distance between the drive substrate 40 and the opposing substrate 50 to a predetermined distance.

The drive substrate 40 may include, for example, thin film transistors (TFTs) 42, a protection layer 43, a planarizing insulating layer 44, and pixel electrodes 45 in this order on one surface of a plate member 41. For example, the TFTs 42 and the pixel electrodes 45 may be arranged in a matrix form or in a segment form depending on pixel arrangement.

For example, the plate member 41 may be formed of an inorganic material, a metallic material, a plastic material, or the like. Examples of the inorganic material may include silicon (Si), silicon oxide (SiOₓ), silicon nitride (SiNₓ), and aluminum oxide (AlOₓ). Examples of the silicon oxide may include glass and spin on glass (SOG). Examples of the metallic material may include aluminum (Al), nickel (Ni), and stainless steel. Examples of the plastic material may include polycarbonate (PC), polyethylene terephthalate (PET), polyethylene naphthalate (PEN), and polyethylether ketone (PEEK).

In the display unit 2, an image is displayed on a side close to the opposing substrate 50, and thus the plate member 41 may have non-optical transparency. The plate member 41 may be configured of a substrate having rigidity such as wafer, or may be configured of a thin layer glass, a film, or the like having flexibility. Using a flexible material for the plate member 41 makes it possible to realize a flexible (foldable) display unit 2.

The TFTs 42 are switching elements to select pixels. The TFTs 42 may be inorganic TFTs using an inorganic semiconductor layer as a channel layer, or organic TFTs using an organic semiconductor layer. For example, the protection layer 43 and the planarizing insulating layer 44 may be formed of an insulating resin material such as polyimide. If the surface of the protection layer 43 is sufficiently flat, the planarizing insulating layer 44 may be omitted. For example, the pixel electrodes 45 may be formed of a metallic material such as gold (Au), silver (Ag), and copper (Cu). The pixel electrodes 45 are connected to the TFTs 42 through contact holes (not illustrated) that are provided in the protection layer 43 and the planarizing insulating layer 44.

For example, the opposing substrate 50 may have a plate member 51 and opposing electrodes 52, and the opposing electrodes 52 are provided on an entire surface (a surface opposed to the drive substrate 40) of the plate member 51. The opposing electrodes 52 may be arranged in a matrix form or in a segment form, as with the pixel electrodes 45.

The plate member 51 is formed of a material similar to that of the plate member 41, except for having optical transparency. For example, a translucent conductive material (a transparent electrode material) such as indium tin oxide (ITO), antimony tin oxide (ATO), fluorine doped tin oxide (FTO), and aluminum doped zinc oxide (AZO) may be used for the opposing electrodes 52.

When an image is displayed on a side close to the opposing substrate 50, the electrophoretic element 1 is viewed through the opposing electrodes 52. Therefore, the optical transparency (transmittance) of the opposing electrodes 52 may be preferably as high as possible, and for example, may be about 80% or more. Moreover, the electric resistance of the opposing electrodes 52 may be preferably as low as possible, and for example, may be about 100 Ω/sq. or lower.

The electrophoretic element 1 in the present application example has a structure similar to that of the electrophoretic element 1 according to the above-described embodiment. Specifically, the electrophoretic element 1 includes the migrating particles 20 and the porous layer 30 including the plurality of pores 33 in the insulating liquid 10. The insulating liquid 10 is filled in a space between the drive substrate 40 and the opposing substrate 50, and the porous layer 30 may be supported by, for example, the spacer 60. The space where the insulating liquid 10 is filled may be segmented into a waiting region R1 on a side close to the pixel electrodes 45 and a display region R2 on a side close to the opposing electrodes 52 with the porous layer 30 as a border. The structures of the insulating liquid 10, the migrating particles 20, and the porous layer 30 are similar to those described in the above-described embodiment. Note that, in FIG. 3 and FIG. 4 described later, a part of the pores 33 is illustrated for simplification of illustration contents.

The porous layer 30 may be adjacent to one of the pixel electrodes 45 and the opposing electrodes 52, and may not be clearly segmented into the waiting region R1 and the display region R2. The migrating particles 20 move toward the pixel electrodes 45 or the opposing electrodes 52 in response to the electric field.

A thickness of the spacer 60 may be, for example, about 10 micrometers to about 100 micrometers both inclusive, and preferably as thin as possible. As a result, power consumption is allowed to be suppressed. For example, the spacer 60 may be formed of an insulating material such as a polymer material, and may be provided, for example, in a lattice shape between the drive substrate 40 and the opposing substrate 50. The arrangement shape of the spacer 60 is not particularly limited, and may be preferably so provided as not to prevent the movement of the migrating particles 20 and to allow the migrating particles 20 to be uniformly distributed.

In the display unit 2 in the initial state, the migrating particles 20 are disposed in the waiting region R1 (FIG. 3). In this case, the migrating particles 20 are shielded by the porous layer 30 in all of the pixels. Therefore, contrast is not generated (an image is not displayed) when the electrophoretic element 1 is viewed from the opposing substrate 50 side.

On the other hand, when the pixels are selected by the TFTs 42 and an electric field is applied between the pixel electrodes 45 and the opposing electrodes 52, as illustrated in FIG. 4, the migrating particles 20 move from the waiting region R1 to the display region R2 through the porous layer 30 (the pores 33) for each pixel. In this case, pixels in which the migrating particles 20 are shielded by the porous layer 30 and pixels in which the migrating particles 20 are not shielded by the porous layer 30 exist together. Therefore, when the electrophoretic element 1 is viewed from the opposing substrate 50 side, the contrast is generated. As a result, an image is displayed.

According to the display unit 2, for example, high-quality images suitable for colorization and moving picture display are allowed to be displayed by the electrophoretic element 1 having high response speed.

### (Electronic Apparatus)

Next, application examples of the above-described display unit 2 will be described.

The display unit 2 according to the present technology is applicable to electronic apparatuses for various purposes, and kinds of the electronic apparatuses are not particularly limited. For example, the display unit 2 is capable of being mounted on the following electronic apparatuses. However, configurations of the electronic apparatuses described below are merely examples, and thus the configurations are appropriately modified.

### Application Example 1

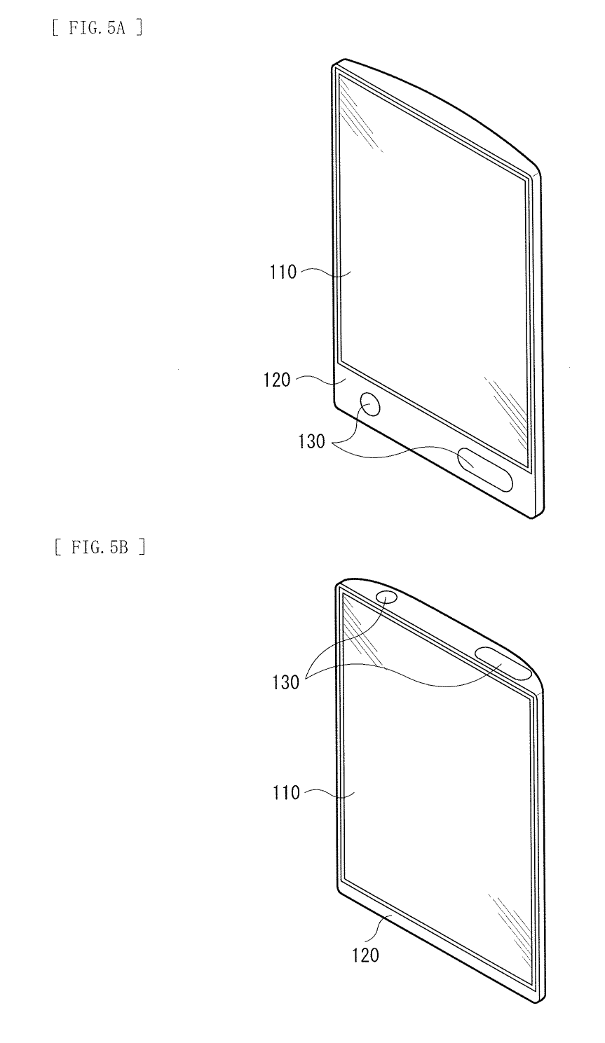

FIGS. 5A and 5B each illustrate an appearance configuration of an electronic book. For example, the electronic book may include a display section 110, a non-display section 120, and an operation section 130. Note that the operation section 130 may be provided on a front surface of the non-display section 120 as illustrated in FIG. 5A or may be provided on a top surface as illustrated in FIG. 5B. The display section 110 is configured of the display unit 2. Note that, the display unit 2 may be mounted on a personal digital assistants (PDA) having a configuration similar to that of the electronic book illustrated in FIGS. 5A and 5B.

### Application Example 2

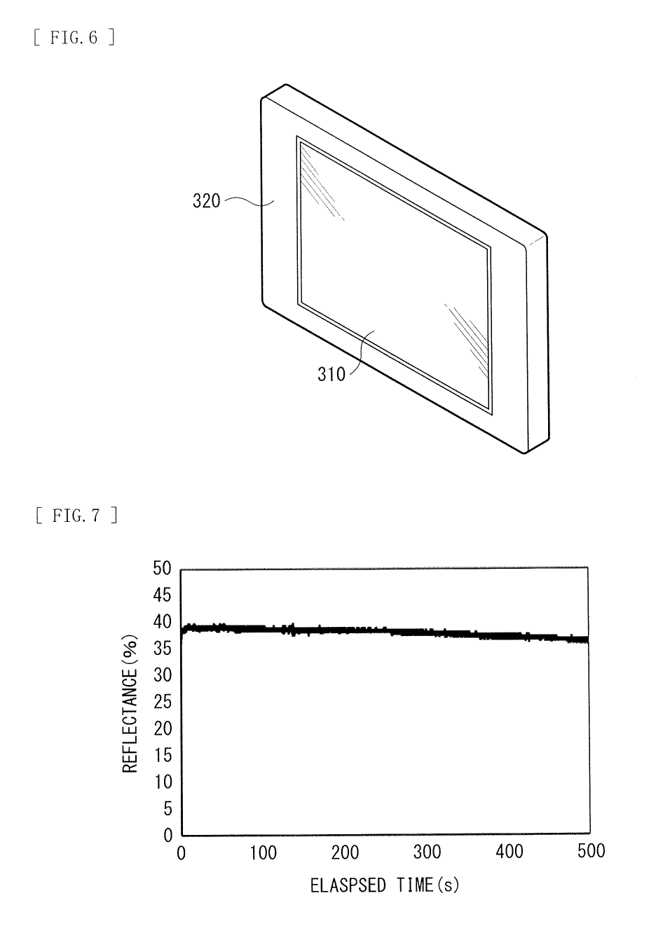

FIG. 6 illustrates an appearance configuration of a tablet personal computer. For example, the tablet personal computer may include a touch panel section 310 and a housing 320, and the touch panel section 310 is configured of the above-described display unit 2.

### 3. Examples

Next, examples of the present technology will be described in detail. A display unit was fabricated by the following procedure with use of black (dark display) migrating particles and a white (bright display) porous layer (particle-containing fibrous structure).

### Experimental Example 1

First, after a mixed solution of 400 ml of tetrahydrofuran and 400 ml of methanol was prepared, 50 g of complex oxide fine particles (oxide of copper, iron, and manganese, DAIPYROXIDE Color TM9550 made by Dainichiseika Color & Chemicals Mfg. Co., Ltd.) was added to the solution, followed by ultrasonic wave stirring (at about 25° C. to about 35° C. for 30 minutes) in a ultrasonic bath. Then, after 40 ml of 28% ammonia water was dropped into the dispersion liquid of the complex oxide file particles for 30 minutes, a solution in which 10 g of plenact KR-TTS (made by Ajinomoto Fine-Techno Co., Inc.) was dissolved in 80 ml of tetrahydrofuran was dropped into the resultant liquid for 30 minutes. Subsequently, after the ultrasonic bath was warmed to 60° C. and held for three hours, the ultrasonic bath was cooled to the room temperature, followed by centrifugation (at 6000 rpm for 10 minutes) and decantation. Then, a precipitate after the decantation was redispersed into a mixed solvent of tetrahydrofuran and methanol (volume ratio=1:1), followed by centrifugation (at 6000 rpm for 10 minutes) and decantation. A precipitate obtained by performing the cleaning operation three times was dried in a vacuum oven at 70° C. over night. As a result, black migrating particles coated with dispersion groups were obtained.

After preparation of the migrating particles, 16.7 g of OLOA1200 (made by Chevron Chemicals) was dissolved to 83.3 g of an insulating liquid to prepare an OLOA1200 solution. 1 g of the above-described migrating particles was added to 9 g of the OLOA1200 solution, followed by ultrasonic dispersion. The dispersion liquid was subjected to centrifugation (at 6000 rpm for 90 minutes) and decantation, and then the resultant was redispersed into the insulating liquid. This operation was repeated three times to perform preparation such that component of the migrating particles in the obtained dispersion liquid became 10 wt %. Then, 1 g of OLOA1200, 10 g of ADDOCONATE S (made by Lubrizol Corporation), and 20 g of the above-described dispersion liquid were added to 69 g of an insulating liquid, followed by stirring, and thus an insulating liquid containing the additives and the migrating particles was obtained.

Then, polymethyl methacrylate was prepared as a material of the fibrous structure. After 14 g of polymethyl methacrylate was dissolved in 86 g of N,N′-dimethylformamide, 30 g of titanium oxide as non-migrating particles having a primary particle diameter of 250 nanometers was added to 70 g of the solution, and the resultant was mixed with a bead mill. As a result, a spinning solution for forming the fibrous structure was obtained. After pixel electrodes formed of ITO in a predetermined pattern were formed on a drive substrate, spinning was performed with use of the spinning solution. Specifically, the spinning solution was put into a syringe, and spinning for 1.2 mg/cm′ was performed on the drive substrate. By the above-described steps, a porous layer (a fibrous structure holding non-migrating particles) was formed on the drive substrate. The spinning was performed with use of an electric field spinning apparatus (NANON manufactured by Mecc Co., Ltd.).

After the porous layer was formed on the drive substrate, unnecessary porous layer was removed from the drive substrate. Specifically, the porous layer at a part where the pixel electrodes were not provided was removed. Opposing electrodes made of ITO were formed on a plate member to form an opposing substrate, and after a spacer of PET film (having a thickness of 30 micrometers) was disposed on the opposing substrate, this was overlaid on the drive substrate provided with the porous layer. At this time, the porous layer was so held by the spacer as to be separated away from the pixel electrodes and the opposing electrodes. Subsequently, the above-described insulating liquid in which the migrating particles were dispersed was injected between the drive substrate and the opposing substrate. Finally, ultraviolet rays were irradiated to a photocurable resin to complete the display unit.

### Experimental Example 2

16.7 g of ADDOCONATE S was dissolved in 83.3 g of the insulating liquid to prepare an ADDOCONATE S solution. 1 g of the above-described migrating particles was added to 9 g of the ADDOCONATE S solution to prepare dispersion liquid in which the component of the migrating particles was 10 wt %. Then, 1 g of OLOA1200, 1.67 g of ADDOCONATE S, and 20 g of the above-described dispersion liquid were added to 76.7 g of the insulating liquid, followed by stirring, and as a result, the insulating liquid containing the additives and the migrating particles was obtained. Except for this point, the display unit was fabricated in the procedure similar to that in the experimental example 1.

### Experimental Example 3

The display unit was fabricated in the procedure similar to that in the experimental example 2 except that PDSA-DA (Sanyo Chemical Industries, Ltd.), sodium di(2-ethylhexyl)sulfosuccinate (AOT: Tokyo Chemical Industry Co., Ltd.), Span80 (Tokyo Chemical Industry Co., Ltd.), dimethyldodecylamine (Tokyo Chemical Industry Co., Ltd.), and trioctylamine (Tokyo Chemical Industry Co., Ltd.) were used as the additives.

### Experimental Example 4

The display unit was fabricated in the procedure similar to that in the experimental example 2 except that isooctadecyl succinic anhydride (Tokyo Chemical Industry Co., Ltd.) and dimethyldodecylamine were used as the additives.

### Experimental Example 5

The display unit was fabricated in the procedure similar to that in the experimental example 2 except that ADDCONATE S, Hypermer KD-9 (Croda Japan KK), and OLOA1200 were used as the additives.

### Experimental Example 6

The display unit was fabricated in the procedure similar to that in the experimental example 2 except that sodium di(2-ethylhexyl)sulfosuccinate (Kanto Chemical Co., Inc.) and 2-ethlhexylamine (Tokyo Chemical Industry Co., Ltd.) were used as the additives.

### Experimental Example 7

The display unit was fabricated in the procedure similar to that in the experimental example 1 except that only OLOA1200 was used as the additive.

### Experimental Example 8

The display unit was fabricated in the procedure similar to that in the experimental example 1 except that only ADDOCONATE S was used as the additive.

As the performance of the display units in the respective experimental examples 1 to 8, a white reflectance (%), a black reflectance (%), and contrast (CR) were measured and the display memory property was evaluated, and results were illustrated in Table 1.

TABLE 1

| | Density | Density | White | Black | | |
|---|---|---|---|---|---|---|
| | of Acidic | of Basic | Reflec- | Reflec- | | |
| | Additive | Additive | tance | tance | | Memory |
| | (wt %) | (wt %) | (%) | (%) | CR | Property |
| Experimental | 10 | 1 | 35 | 3.0 | 12 | Circle |
| Example 1 | | | | | | |
| Experimental | 1.67 | 1.67 | 40 | 1.8 | 23 | Circle |
| Example 2 | | | | | | |
| Experimental | 2.5 | 0.5 | 39 | 1.2 | 33 | Double |
| Example 3 | | | | | | Circle |
| Experimental | 2.0 | 0.5 | 34 | 3.4 | 10 | Circle |
| Example 4 | | | | | | |
| Experimental | 0.4/0.4 | 0.3 | 37 | 1.3 | 28 | Circle |
| Example 5 | | | | | | |
| Experimental | 0.1 | 0.01 | 41 | 3.0 | 14 | Circle |
| Example 6 | | | | | | |
| Experimental | — | 1.67 | 42 | 1.3 | 32 | Triangle |
| Example 7 | | | | | | |
| Experimental | 10 | — | — | — | — | Cross |
| Example8 | | | | | | |

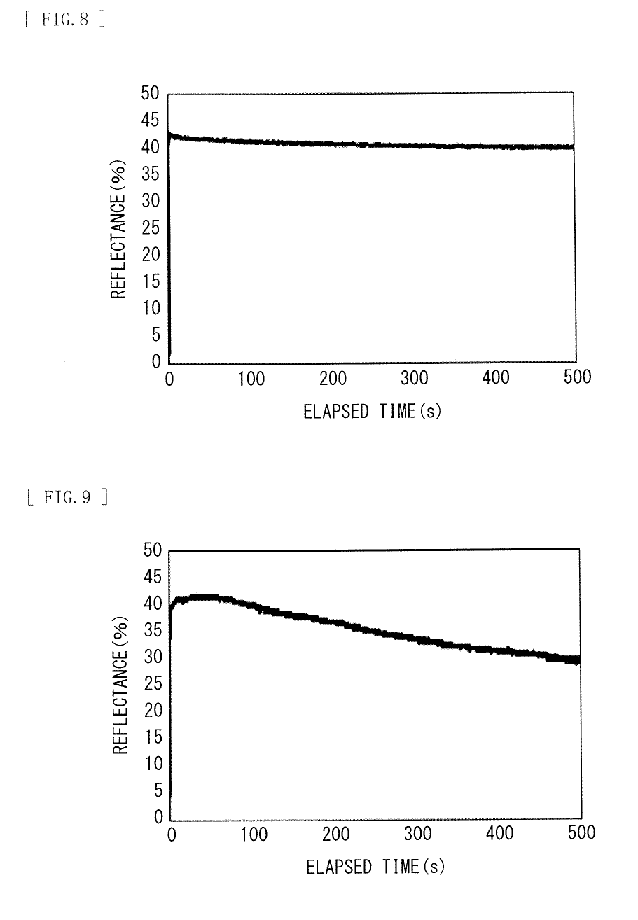

The contrast was calculated from the white reflectance (%) and the black reflectance (%) as the contrast=the white reflectance (%)/the black reflectance (%). As for the white reflectance and the black reflectance, after an AC voltage (0.1 Hz and 15V) was applied to the display unit for one hour, a reflectance in a direction normal to the substrate with respect to a standard diffuser under 45° ring illumination was measured using a spectrophotometer (CD100 manufactured by Yokogawa Electric Corporation). As for the display memory property, temporal variation of the white reflectance after the application of the voltage was stopped was measured, and variation ratio between the reflectance immediately before the application of the voltage is stopped and the reflectance after 10 minutes was calculated, and it was determined that the display memory property was high as the variation ratio was small. Specifically, the variation ratio of 5% or lower was denoted by a double circle, the variation ratio lower than 20% was denoted by a circle, and the variation ratio of 20% or higher was denoted by a triangle. Incidentally, FIGS. 7 to 9 each illustrate the temporal variation of the reflectance after the application of the electric field is stopped in the experimental example (FIG. 7), the experimental example 3 (FIG. 8), and the experimental example 7 (FIG. 9).

As can be seen in Table 1 and FIGS. 7 and 8, in the experimental examples 1 to 6 in which the acidic additive and the basic additive were mixed, all of the variation of the reflectance in 10 minutes after the application of the voltage was stopped were within 15%, and in the experimental example 3, high display memory property of 5% or lower was exhibited. In contrast, in the experimental example 7 in which only the basic additive was used, the reflectance after the application of the electric field was stopped was largely varied as can be seen in FIG. 9, and specifically, was varied by 20% or higher. In addition, in the experimental example 8 in which only the acidic additive was used, black and white were not inverted.

In this way, adding both of the acidic additive and the basic additive to the insulating liquid provides high display memory property. In other words, it is possible to provide a display unit having excellent memory characteristics.

Hereinbefore, although the technology has been described with referring to the embodiment and the examples, the technology is not limited to the above-described embodiment and the like, and various modifications may be made.

Note that the effects described in the present specification are illustrative and non-limiting. Effects achieved by the technology may be effects other than those described above.

Note that the technology may be configured as follows.

(1)

A display unit including: in an insulating liquid, migrating particles;

a porous layer including non-migrating particles and formed of a fibrous structure, the non-migrating particles having an optical reflectance different from an optical reflectance of the migrating particles; and
an acidic additive and a basic additive.
(2)

The display unit according to (1), wherein the acidic additive has a succinic anhydride structure.

(3)

The display unit according to (1) or (2), wherein the acidic additive has a succinic structure.

(4)

The display unit according to any one of (1) to (3), wherein the basic additive has a succinic imide structure.

(5)

The display unit according to any one of (1) to (4), wherein the basic additive is amine.

(6)

The display unit according to any one of (1) to (5), wherein a plurality of kinds of the acidic additives and a plurality of kinds of the basic additives are contained.

(7)

The display unit according to any one of (1) to (6), wherein an average fiber diameter of the fibrous structure is about 0.1 micrometer or larger and 10 micrometers or lower.

(8)

The display unit according to any one of (1) to (7), wherein the fibrous structure is formed by an electrostatic spinning method.

(9)

The display unit according to any one of (1) to (8), wherein an optical reflectance of the non-migrating particles is higher than an optical reflectance of the migrating particles, and the migrating particles perform dark display and the non-migrating particles and the fibrous structure perform bight display.

(10)

The display unit according to any one of (1) to (9), wherein the migrating particles and the non-migrating particles are formed of one or more of an organic pigment, an inorganic pigment, a dye, a carbon material, a metallic material, a metal oxide, glass, and a polymer material.

(11)

The display unit according to any one of (1) to (10), wherein the fibrous structure is formed of one or both of a polymer material and an inorganic material.

(12)

An electronic apparatus provided with a display unit, the display unit including: in an insulating liquid,

migrating particles;
a porous layer including non-migrating particles and formed of a fibrous structure, the non-migrating particles having an optical reflectance different from an optical reflectance of the migrating particles; and
an acidic additive and a basic additive.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Electrophoretic element
2 Display unit
10 Insulating liquid
20 Migrating particle
21A Acidic additive
21B Basic additive
30 Porous layer
31 Fibrous structure
32 Non-migrating particle
33 Pore
40 Drive substrate
41, 51 Plate member
42 TFT
43 Protection layer
44 Planarizing insulating layer
45 Pixel electrode
50 Opposing substrate
52 Opposing electrode
60 Spacer

1. A display unit comprising: in an insulating liquid,
migrating particles;
a porous layer including non-migrating particles and formed of a fibrous structure, the non-migrating particles having an optical reflectance different from an optical reflectance of the migrating particles; and
an acidic additive and a basic additive.

2. The display unit according to claim 1, wherein the acidic additive has a succinic anhydride structure.

3. The display unit according to claim 1, wherein the acidic additive has a succinic structure.

4. The display unit according to claim 1, wherein the basic additive has a succinic imide structure.

5. The display unit according to claim 1, wherein the basic additive is amine.

6. The display unit according to claim 1, wherein a plurality of kinds of the acidic additives and a plurality of kinds of the basic additives are contained.

7. The display unit according to claim 1, wherein an average fiber diameter of the fibrous structure is about 0.1 micrometer or larger and 10 micrometers or lower.

8. The display unit according to claim 1, wherein the fibrous structure is formed by an electrostatic spinning method.

9. The display unit according to claim 1, wherein
an optical reflectance of the non-migrating particles is higher than an optical reflectance of the migrating particles, and
the migrating particles perform dark display and the non-migrating particles and the fibrous structure perform bight display.

10. The display unit according to claim 1, wherein the migrating particles and the non-migrating particles are formed of one or more of an organic pigment, an inorganic pigment, a dye, a carbon material, a metallic material, a metal oxide, glass, and a polymer material.

11. The display unit according to claim 1, wherein the fibrous structure is formed of one or both of a polymer material and an inorganic material.

12. An electronic apparatus provided with a display unit, the display unit comprising: in an insulating liquid,
migrating particles;
a porous layer including non-migrating particles and formed of a fibrous structure, the non-migrating particles having an optical reflectance different from an optical reflectance of the migrating particles; and
an acidic additive and a basic additive.
